(19) United States
(12) Patent Application Publication
(10) Pub. No.: US 2014/0056000 A1
(43) Pub. Date: Feb. 27, 2014

(54) ASSEMBLING STRUCTURE OF ILLUMINATION UNIT

(71) Applicant: Yazaki Corporation, Tokyo (JP)

(72) Inventor: Toshinobu TSUSHIMA, Makinohara-shi (JP)

(73) Assignee: Yazaki Corporation, Tokyo (JP)

(21) Appl. No.: 14/068,821

(22) Filed: Oct. 31, 2013

Related U.S. Application Data
(63) Continuation of application No. PCT/JP2012/064732, filed on Jun. 1, 2012.

(30) Foreign Application Priority Data
Jun. 3, 2011 (JP) 2011-124796

(51) Int. Cl. F21V 15/01

(52) U.S. Cl. CPC F21V 15/01
USPC 362/249.01; 362/362

(57) ABSTRACT

In an assembling structure of an illumination unit, a light emitting component is mounted on a circuit board, and a housing accommodates the circuit board on which the light emitting component is mounted. A housing light-emitting part is formed at the housing, and transmits light emitted from the light emitting component. A housing light-blocking part is formed at the housing around the housing light-emitting part, and blocks the light emitted from the light emitting component. The housing is configured to be assembled into an assembled subject. The housing includes an exposed surface being a plane and including an outer surface of the housing light-emitting part and an outer surface of the housing light-blocking part are provided. The assembled subject includes a slit which forms an opening through which the exposed surface of the housing is exposed.

### CROSS REFERENCE TO RELATED APPLICATIONS

This application is a continuation of PCT application No. PCT/JP2012/064732, which was filed on Jun. 1, 2012 based on Japanese Patent Application (No. 2011-124796) filed on Jun. 3, 2011, the contents of which are incorporated herein by reference.

### BACKGROUND OF THE INVENTION

1. Field of the Invention

The present invention is related to an assembling structure for assembling an illumination unit to an assembled subject, that is, an assembling structure for the illumination unit.

2. Description of the Related Art

An illumination unit for illuminating an illuminated member etc. has been provided at various portions. For example, in an electric car or a hybrid car, an illumination unit is provided in a vicinity of a charging connector for charging a battery. The charging connector is configured by a feeding side connector and a vehicle side connector (vehicle side inlet). The illumination unit is provided near the vehicle side connector.

A PTL 1 described below discloses a technique relating to the charging connector. According to this disclosed technique, the vehicle side connector is provided within a vehicle side housing of a vehicle. A light emitting component (lamp) as well as the vehicle side connector is also provided within the vehicle side housing. The light emitting component is a component constituting the illumination unit which is configured to be turned on and off at the time of opening and closing an opening/closing lid of the vehicle side housing, respectively. The light emitting component is provided so as to facilitate coupling and releasing works of the feeding side connector and the vehicle side connector in the night. The light emitting component is provided within the vehicle side housing in an exposed and protruded state.

### CITATION LIST

[Patent Literature]
[PTL 1] JP-A-6-325834

### SUMMARY OF THE INVENTION

In a case where the light emitting component is exposed, since there arises a case that the feeding side connector collides with the light emitting component at the time of the coupling and releasing works, this technique has a problem that light emitting component may be broken. In order to obviate this problem, it is considered to take a measure of covering the light emitting component by a housing. Hereinafter, explanation will be made as to a structure in the case of covering the light emitting component by the housing in accordance with a related art which is investigated by the inventors as the proposed measure, and the problem thereof.

In FIG. 5, an illumination unit 1 of the related art includes a circuit board 2. LEDs 3, 4 as light emitting components are mounted on this circuit board 2. The circuit board 2 mounting the LEDs 3, 4 thereon is accommodated within a housing 5. That is, the LEDs 3, 4 and the circuit board 2 are covered by the housing 5. The housing 5 is transparent so as to have optical transparency as a whole. The housing 5 is covered by a design cover 6. The housing 5 and the design cover 6 are engaged and locked to each other by the engagement between an engagement projection 7 and an engagement concave 8. An opening 10 for passing light 9 which is emitted from the LED 3 and transmitted through the housing 5 is formed at the design cover 6. An opening 12 for passing light 11 which is emitted from the LED 4 and transmitted through the housing 5 is also formed at the design cover 6. The LED 3 is provided in order to illuminate a not-shown vehicle side connector. The LED 4 is provided in order to illuminate an indicator 13.

According to the configuration and structure of FIG. 5, the size of each of the portion of the housing 5 for transmitting the light 9 emitted from the LED 3 and the opening 10 of the design cover 6 is relatively small. Thus, when a step shown by an arrow X becomes large, there arises a problem that the diffusion property of the light 9 degrades.

Further, according to the configuration and structure of FIG. 5, since the size of the portion of the housing 5 for transmitting the light 9 emitted from the LED 3 is relatively small, at the time of covering the housing 5 by the design cover 6, the portion for transmitting the light may be rubbed against the opening until the portion for transmitting the light reaches the opening 10 of the design cover 6. As a result, there also may arise a problem that the transmission property of the light 9 is badly influenced.

Furthermore, according to the configuration and structure of FIG. 5, since the transparent housing 5 is covered by the design cover 6, there arises a problem that when the light 9 emitted from the LED 3 reflects on the inner surface of the housing 5 etc., the reflected light 14 leaks from the opening 12.

It is therefore one advantageous aspect of the present invention to provide an assembling structure for an illumination unit which can enhance the diffusion property of light, prevent the rubbing of a part for transmitting light and also prevent the leakage of the light.

According to one advantage of the invention, there is provided an assembling structure of an illumination unit, comprising:

a circuit board;

a light emitting component mounted on the circuit board;

a housing accommodating the circuit board on which the light emitting component is mounted;

a housing light-emitting part, formed at the housing, and configured to transmit light emitted from the light emitting component;

a housing light-blocking part, formed at the housing around the housing light-emitting part, and configured to block the light emitted from the light emitting component; and

an assembled subject into which the housing is configured to be assembled,

wherein the housing includes an exposed surface being a plane and including an outer surface of the housing light-emitting part and an outer surface of the housing light-blocking part are provided, and

wherein the assembled subject includes a slit which forms an opening through which the exposed surface of the housing is exposed.

The assembling structure may be configured such that the housing has a concave part which is formed by sinking the outer surface of the housing light-blocking part, and outer edge part of the slit is engaged with the concave part.

The assembled subject may have a convex-shaped collision preventing part which is provided at the outer edge part of the slit so as to protrude than the exposed surface.

The assembling structure may further comprise: a second light emitting component mounted on the circuit board; and a second housing light-emitting part, formed at the housing, and configured to transmit second light emitted from the second light emitting component, and may be configured such that the circuit board mounting the light emitting component and the second light emitting component thereon is accommodated within the housing at a position where the light emitted from the light emitting component does not mix with the second light emitted from the second light emitting component.

According to the invention, when the illumination unit is assembled to the assembled subject, the outer surfaces of the housing light-emitting part and the housing light-blocking part of the illumination unit are exposed at the opening surface of the slit of the assembled subject, on the substantially same plane as the opening surface. The housing light-emitting part has the housing light-blocking part at the circumferential periphery thereof and these parts are located at the almost same plane as the opening surface of the slit. Further, these parts are relatively widely exposed from the slit, so that there is no step portion in the diffusion direction of the light. Further, according to this invention, since the slit of the assembled subject has the large opening for exposing the outer surface of each of the housing light-emitting part and the housing light-blocking part of the illumination unit, the rubbing of the housing light-emitting part can be prevented at the time of assembling the illumination unit to the assembled subject. Furthermore, according to this invention, since the housing is configured to have the housing light-blocking part at the circumferential periphery of the housing light-emitting part, the leakage of the light can be prevented by the housing light-blocking part.

Accordingly, this invention can attain the technical effects that the diffusion property of light can be enhanced, the rubbing of the light transmitting part can be prevented and also the leakage of the light can be prevented.

According to the invention, there is no step portion in the diffusion direction of the light by engaging the slit outer edge part with the concave part of the housing.

Accordingly, this invention can attain the technical effects that the structure effective of further enhancing the light diffusion property can be provided.

According to the invention, since the slit outer edge part has the collision preventing part, the physical collision with the housing light-emitting part can be prevented.

Accordingly, in addition to the aforesaid technical effects, this invention can attain the technical effects that the part for transmitting the light can be protected.

According to the invention, the leakage of the light can be prevented more surely by suitably setting the housing position of the circuit board in addition to the provision of the housing light-blocking part.

Accordingly, this invention can attain the technical effects that the leakage of the light from the second housing light-emitting part can be prevented.

### BRIEF DESCRIPTION OF THE DRAWINGS

FIG. 1 is a perspective view showing an assembled state in accordance with a first embodiment of the assembling structure of an illumination unit of the invention.

FIG. 2 is a sectional diagram of FIG. 1.

FIG. 3 is a perspective view showing an assembled state in accordance with a second embodiment of the assembling structure of an illumination unit of the invention.

FIG. 4 is a sectional diagram of FIG. 3.

FIG. 5 is a sectional view showing a structure where light-emitting components are covered by a housing in accordance with a related art.

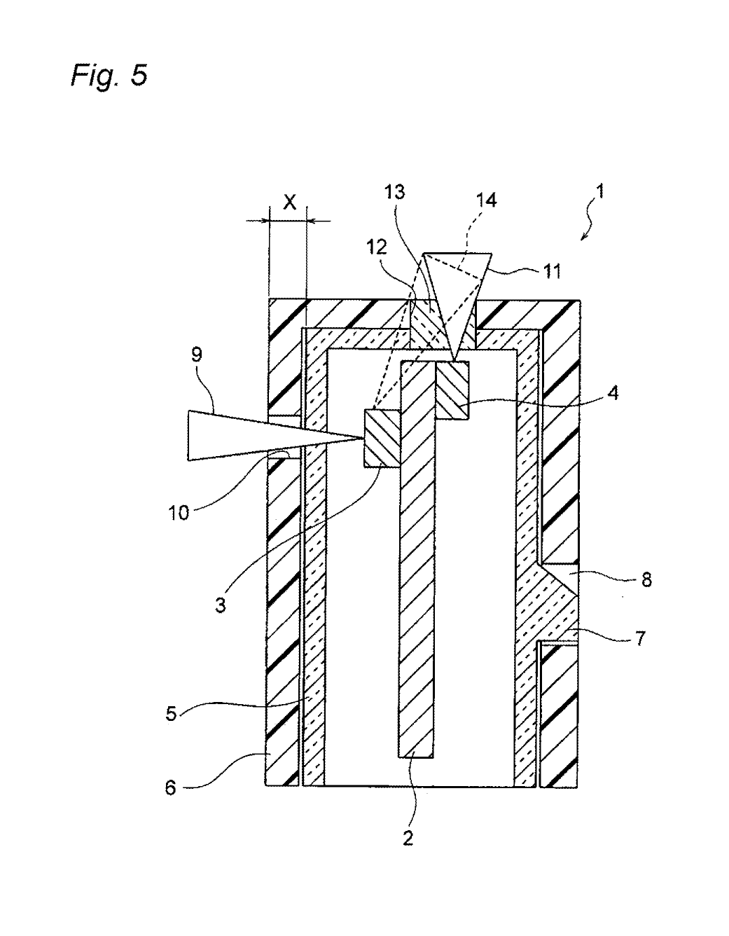

### DETAILED DESCRIPTION OF THE EXEMPLARY EMBODIMENTS

The assembling structure for an illumination unit according to this invention is configured that when the illumination unit is assembled with respect to an assembled subject, the outer surface of the housing light-emitting part and the outer surface of the housing light-blocking part of the illumination unit are entirely exposed almost on the same plane and are largely exposed relatively.

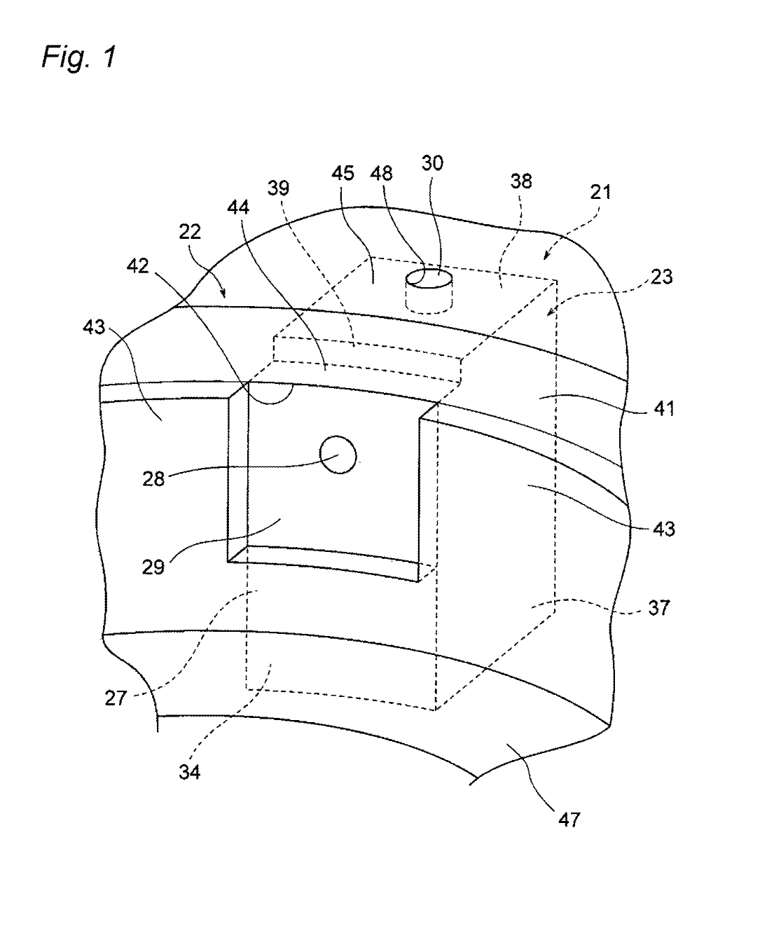

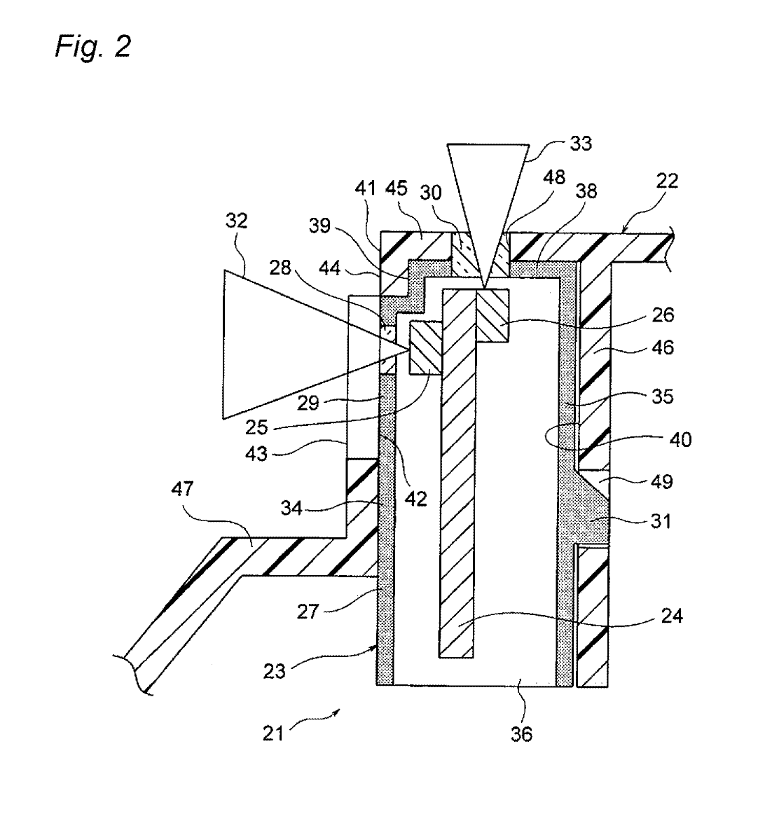

Hereinafter, the first embodiment will be explained with reference to drawings. FIG. 1 is a perspective view showing an assembled state according to the assembling structure for an illumination unit of the first embodiment. FIG. 2 is a sectional view of FIG. 1.

In the following explanation, concrete shapes, material, numerical values and directions etc. are mere examples for facilitating the understanding of this invention and hence can be suitably changed according to the usage, object, specification etc. Further, although the following explanation is made as to the charging connector of an electric car or a hybrid car as an example of an illuminated subject, the illuminated subject is not limited to the charging connector. In the following explanation, the “illumination unit” may be replaced by a “lamp unit”.

In FIGS. 1 and 2, a reference numeral 21 depicts the illumination unit. The illumination unit 21 is assembled to a vehicle body 22. The vehicle body 22 is an assembled subject to which the illumination unit 21 is assembled. The illumination unit 21 is configured by including an illumination unit body 23 and a not-shown electric coupling means for supplying electric power etc. to the illumination unit body 23.

The not-shown electric coupling means is configured by including a plurality of electric wires, a connector coupled to the terminals of the electric wires and fixing members such as clips, for example (as an example). The illumination unit body 23 is configured so as to be able to illuminate a not-shown charging connector and to emit light from an indicator 30 described later.

The illumination unit body 23 is configured by including a circuit board 24, LEDs 25, 26 as light emitting components, and a housing 27. The circuit board 24 has a desired circuit pattern. The LEDs 25, 26 are mounted on the one end side of the circuit board 24. A known LED is used as each of the LEDs 25, 26. The LED 25 is mounted at a position, on the one major surface of the circuit board 24, capable of illuminating the not-shown charging connector. The LED 26 is mounted at a position, on the other major surface of the circuit board 24, capable of illuminating the indicator 30 described later. The LEDs 25, 26 are respectively an light emitting component and a second light emitting component, and known lamps may be used in place of these LEDs.

The housing 27 is a resin component for accommodating the circuit board 24 mounting the LEDs 25, 26 thereon. The housing 27 has a housing light-emitting part 28, a housing light-blocking part 29, the indicator 30 (second housing light-emitting part) and an engagement projection 31.

The housing light-emitting part 28 is formed as a transparent part for transmitting light 32 emitted from the LED 25. The housing light-blocking part 29 is formed as a part which is disposed at the circumferential periphery of the housing light-emitting part 28 and can prevent the transmission of the light 32. The housing light-emitting part 28 is formed in a circular shape having a predetermined diameter. The indicator 30 is formed as a transparent part for transmitting light 33 emitted from the LED 26. The indicator 30 is formed as a part for displaying a charging state by the illumination.

In the housing 27, a reference numeral 34 depicts a front wall, 35 depicts a rear wall, 36 and 37 respectively depict left and right side walls, and 38 depicts a top wall. A concave part 39 is formed at a boundary portion between the front wall 34 and the top wall 38. The concave part 39 is formed by sinking the outer surface of the housing light-blocking part 29 of each of the front wall 34 and the top wall 38. Each of the concave part 39 and the housing light-blocking part 29 of the front wall 34 etc. is formed so as to cope with the shape of the vehicle body 22. In this embodiment, each of the concave part and the housing light-blocking part etc. is formed in a curved shape.

Each of the housing light-emitting part 28 and the housing light-blocking part 29 is formed by a known double molding but the forming method thereof is not limited thereto. In this embodiment, the housing light-blocking part 29 is not formed so as to occupy almost the entire portion of the housing 27. The housing light-blocking part 29 is painted by the same color as that of the vehicle body 22, for example. The coloring is an example. Of course, the assembling structure looks nice when painted by the same color. As the color, a color having high light blocking property such as block is preferable.

The housing light-emitting part 28 is formed and disposed at the front wall 34 together with the housing light-blocking part 29. The housing light-emitting part 28 and the housing light-blocking part 29 of the front wall 34 are formed in a manner that the outer surfaces thereof are formed on the same plane. The indicator 30 is formed and disposed at the top wall 38 together with the housing light-blocking part 29.

The concave part 39 is formed in a concave shape in a manner that the thick portion thereof locates on the circuit board 24 side than the light emitting surface of the LED 25. In the housing 27, since the concave part 39 is disposed at the boundary portion, the thick portion of the concave part 39 interferes with the light 32 emitted from the LED 25 so as not to leak the light on the indicator 30 side. Of course, the arrangement of the circuit board 24 and the mounting positions of the LEDs 25, 26 are also important in order not to leak the light 32 on the indicator 30 side.

The engagement projection 31 is formed and disposed at the rear wall 35. The engagement projection 31 is formed as an engagement part at the time of assembling the illumination unit body 23 to the vehicle body 22. The engagement projection 31 is formed in an almost claw shape. The engagement projection 31 has a tapered surface and an engagement surface etc. The engagement projection 31 is configured so as to be caught by and engage with the engagement concave part 49 described later of the vehicle body 22.

The vehicle body 22 corresponds to a part for disposing the vehicle side connector of the charging connector in this embodiment, that is, a vehicle side housing. The vehicle body 22 has an illumination unit housing part 40 and is configured that the illumination unit body 23 can be attached to the illumination unit housing part 40. The vehicle body 22 may be formed by metal or resin.

The vehicle body 22 includes a housing front wall 41, a slit 42 formed by notching the housing front wall 41, a collision preventing part 43 formed so as to protrude from the housing front wall 41, a slit outer edge part 44 which is formed at the housing front wall 41 and acts as the outer edge of the slit 42, a housing top wall 45 continued from the housing front wall 41 so as to be orthogonal thereto, and an assembling guide wall 46 formed at the inner side of the housing top wall 45 in an continuous manner therefrom. The illumination unit housing part 40 is formed as a portion surrounded by the housing front wall 41, the slit 42, the slit outer edge part 44, the housing top wall 45 and the assembling guide wall 46.

The housing front wall 41 and the collision preventing part 43 are formed so as to be continuous to the base wall 47 of the vehicle body 22. The collision preventing part 43 is formed so as to protrude with respect to the slit outer edge part 44 as well as the housing front wall 41. The collision preventing part 43 is formed so as to be able to protect a portion protruding from the slit 42. To be concrete, the collision preventing part 43 is formed so that the physical collision with the housing light-emitting part 28 can be prevented. The collision preventing part 43 is formed as a convex-shaped portion protruding than the opening surface of the slit 42 described later.

The slit 42 is formed to have the opening surface (reference numeral thereof is omitted) located almost on the same plane as the outer surface of each of the housing light-emitting part 28 and the housing light-blocking part 29 when the illumination unit body 23 is assembled to the illumination unit housing part 40. The slit 42 is formed to have a relatively large opening so that the housing light-blocking part 29 as well as the housing light-emitting part 28 can be exposed therefrom. The slit 42 is formed to be sufficiently large with respect to the housing light-emitting part 28. To be concrete, the slit 42 is formed to have such the large opening that there is no step portion on the vehicle body 22 side in the diffusion direction of the light 32 transmitting through the housing light-emitting part 28.

The slit outer edge part 44 is formed that the outer surface thereof locates almost on the same plane as the opening surface of the slit 42. Further, the slit outer edge part 44 is formed in a manner that the thick portion thereof is accommodated within the concave part 39 of the housing 27. When the illumination unit body 23 is assembled to the illumination unit housing part, the slit outer edge part 44 can be engaged with the concave part 39 of the housing 27. Further, the slit outer edge part 44 is formed as a portion not protruding from the opening surface of the slit 42.

A through hole 48 for exposing the indicator 30 of the housing 27 is formed at the housing top wall 45. The indicator 30 exposed from the through hole 48 is formed and disposed that the outer surface thereof locates almost on the same plane as the outer surface of the housing top wall 45. The outer surface of the indicator 30 acts as light-emitting surface or display surface.

The assembling guide wall 46 is formed as a portion acting as a guide at the time of assembling the illumination unit body 23. The engagement concave part 49 for catching and engaging with the engagement projection 31 of the housing 27 is formed at the assembling guide wall 46 thus configured.

In the aforesaid configuration and structure, according to this invention, when the illumination unit body 23 of the illumination unit 21 is assembled to the vehicle body 22 as the assembled subject, the outer surfaces of the housing light-emitting part 28 and the housing light-blocking part 29 of the illumination unit body 23 are exposed at the opening surface of the slit 42 of the vehicle body 22 on the almost same plane as the opening surface. The housing light-emitting part 28 has the housing light-blocking part 29 at the circumferential periphery thereof and these parts are located at the almost same plane as the opening surface of the slit 42. Further, these parts are relatively widely exposed from the slit 42, so that there is no step portion in the diffusion direction of the light 32 emitted from the LED 25.

The housing 27 includes an exposed surface being a plane and including the outer surface of the housing light-emitting part 28 and the outer surface of the housing light-blocking part 29 are provided. The vehicle body 22 includes the slit 42 which forms an opening through which the exposed surface of the housing 27 is exposed.

Further, according to this invention, since the slit 42 of the vehicle body 22 has the large opening for exposing the outer surface of each of the housing light-emitting part 28 and the housing light-blocking part 29 of the illumination unit body 23, the rubbing of the housing light-emitting part 28 can be prevented at the time of assembling the illumination unit body 23 to the vehicle body 22.

Furthermore, according to this invention, since the housing 27 is configured to have the housing light-blocking part 29 at the circumferential periphery of the housing light-emitting part 28, the leakage of the light 32 emitted from the LED 25 can be prevented by the housing light-blocking part 29.

As described above, this invention can attain the technical effects that the assembling structure for the illumination unit 21 can be provided which can enhance the diffusion property of light, prevent the rubbing of the light transmitting part and also prevent the leakage of the light.

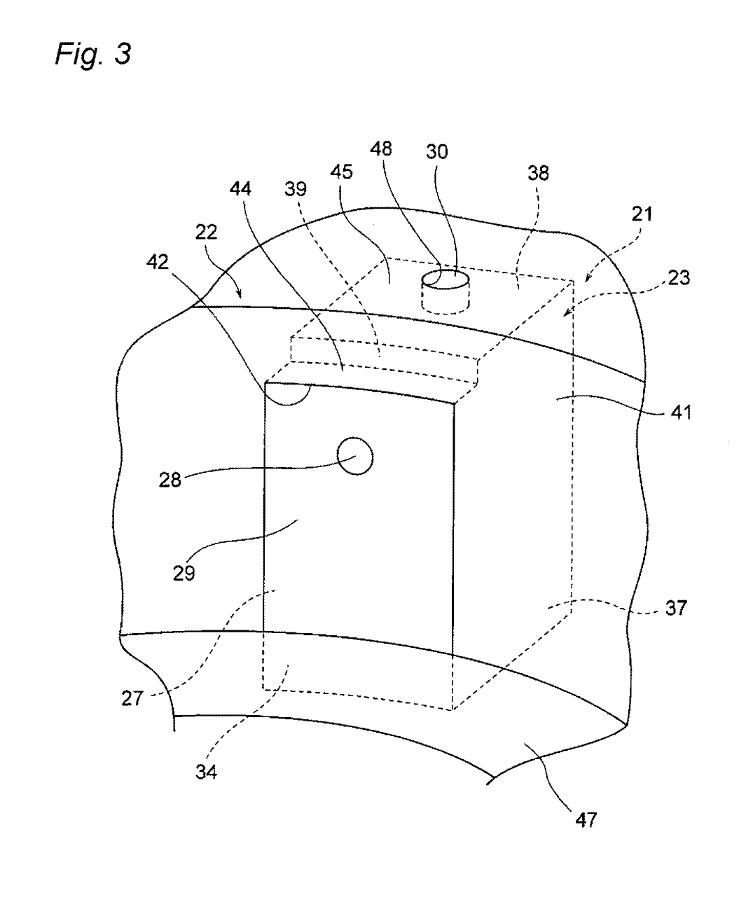

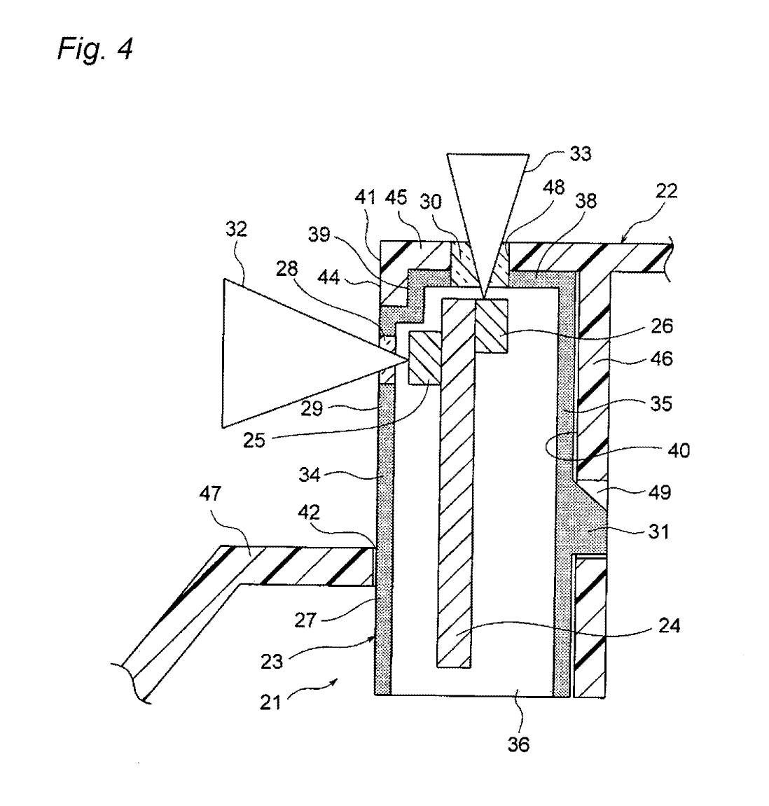

Hereinafter, the second embodiment will be explained with reference to drawings. FIG. 3 is a perspective view showing an assembled state according to the assembling structure for an illumination unit of the second embodiment. FIG. 4 is a sectional view of FIG. 3.

In these figures, constituent members identical to those of the first embodiment are referred to by the common symbols, with detailed explanation thereof being omitted.

In FIGS. 3 and 4, the second embodiment differs from the first embodiment in the following point. That is, the second embodiment differs from the first embodiment only in a point that the collision preventing part 43 is not provided at the vehicle body 22 acting as the assembled subject.

The slit 42 and the slit outer edge part 44 are formed at the housing front wall 41 of the vehicle body 22. When the illumination unit body 23 is assembled to the vehicle body 22, the housing light-emitting part 28 and the housing light-blocking part 29 each located at the almost same plane as the opening surface of the slit are exposed from the slit 42.

Like the first embodiment, the second embodiment also has the technical effects that the diffusion property of light can be enhanced, the rubbing of the light transmitting part can be prevented and also the leakage of the light can be prevented.

In addition, of course, this invention can be changed and implemented in various manners in a range not changing the gist of this invention.

The above-mentioned embodiment is merely a typical example of the present invention, and the present invention is not limited to the embodiment. That is, the present invention can be variously modified and implemented without departing from the essential features of the present invention.

The present invention is useful for providing an assembling structure for an illumination unit which can enhance the diffusion property of light, prevent the rubbing of a part for transmitting light and also prevent the leakage of the light.

What is claimed is:

1. An assembling structure of an illumination unit, comprising:
a circuit board;
a light emitting component mounted on the circuit board;
a housing accommodating the circuit board on which the light emitting component is mounted;
a housing light-emitting part, formed at the housing, and configured to transmit light emitted from the light emitting component;
a housing light-blocking part, formed at the housing around the housing light-emitting part, and configured to block the light emitted from the light emitting component; and
an assembled subject into which the housing is configured to be assembled,
wherein the housing includes an exposed surface being a plane and including an outer surface of the housing light-emitting part and an outer surface of the housing light-blocking part are provided, and
wherein the assembled subject includes a slit which forms an opening through which the exposed surface of the housing is exposed.

2. The assembling structure according to claim 1,
wherein the housing has a concave part which is formed by sinking the outer surface of the housing light-blocking part, and
wherein outer edge part of the slit is engaged with the concave part.

3. The assembling structure according to claim 2,
wherein the assembled subject has a convex-shaped collision preventing part which is provided at the outer edge part of the slit so as to protrude than the exposed surface.

4. The assembling structure according to claim 1, further comprising:
a second light emitting component mounted on the circuit board: and
a second housing light-emitting part, formed at the housing, and configured to transmit second light emitted from the second light emitting component,
wherein the circuit board mounting the light emitting component and the second light emitting component thereon is accommodated within the housing at a position where the light emitted from the light emitting component does not mix with the second light emitted from the second light emitting component.
